(19) United States
(12) Patent Application Publication
(10) Pub. No.: US 2010/0171615 A1
(43) Pub. Date: Jul. 8, 2010

(54) System for Detection of Underwater Objects

(76) Inventors: Mark Rhodes, West Lothlan (GB); Brendan Hyland, Edinburgh (GB); Alexander Ballantyne, Edinburgh (GB)

Correspondence Address: Goodwin Procter LLP;Attn: Patent Administrator, 135 Commonwealth Drive, Menlo Park, CA, 94025-1105, US

(21) Appl. No.: 12/524,874

(22) PCT Filed: Jan. 31, 2008
(86) PCT No.: PCT/GB2008/000322

§ 371 Date: Mar. 1, 2010

(30) Foreign Application Priority Data
Jan. 31, 2007 (GB) 0701743.7

(51) Int. Cl. G08B 13/24

(52) U.S. Cl. 340/551

(57) ABSTRACT

An underwater detection system comprising: at least one transmitter (14) for transmitting electromagnetic and/or magneto-inductive signals through water; at least one receiver (15, 16); means for monitoring a signal received from the transmitter (14), and means for using the monitored signal both as a reference and to identify any change or changes in the received signal to infer the presence of an interposing object.

### INTRODUCTION

The present invention relates to a system and method for detecting the presence of underwater objects, which may infiltrate the region of a security boundary or virtual fence.

### BACKGROUND

In air, electromagnetic waves are well known in various radar systems and similar applications for locating target objects. Electromagnetic energy is typically directed from a transmitter towards the vicinity of a potential target object and any reflected signal is taken to result from the presence of an object. Moreover, the position coordinates of the target can be inferred from the angular direction of return of the signal and the radial range from its return delay. Transmitter and receiver are usually co-located, but need not be provided they are cooperative and synchronised with each other. In typical defence situations radar and related systems are used for discovering the existence of objects, which may be regarded as undesirable intruders.

In contrast to aerial or terrestrial conditions, detection of the presence of objects underwater has hitherto been a difficult problem to solve. Techniques that are dependent on a reflected signal are not usually viable underwater. This is because the attenuation of electromagnetic waves is very much greater in water than in air over both the forward and return paths, and the proportion of energy reflected is very small, so that the received signal is usually too weak to be detected at useful ranges. This is particularly true for seawater, whose conductivity results in still greater attenuation than relatively fresh water. Although lower frequencies can provide reduced attenuation, there are inherent physical difficulties, which in practice render insurmountable the launching of signals with sufficient energy at necessary low frequencies. Thus, according to the methods of this invention a different principle is adopted for detecting the presence of objects underwater.

U.S. Pat. No. 5,019,822 describes how a disturbance of the phase and amplitude of an electromagnetic signal in water might be used to detect the introduction of a swimmer to a body of water. According to U.S. Pat. No. 5,019,822, a separate phase reference signal transmitted over an air path to both transmitter and receiver is used as a mutual reference for signal phase and amplitude. Effectively, the receiver attempts to detect changes in phase difference between the signal received over the air path and that over the water path disturbed by the swimmer. However, using phase and amplitude difference and a separate reference path has a number of inherent shortcomings. In particular, the presence of antennas above water may prevent the system being covert and make it liable to avoidance or sabotage. In addition, the requirement for a reference air path introduces undesirable complications, such as the susceptibility of that reference air path to disturbance by aerial or surface objects such as passing ships. Also, only a limited detection barrier of modest extent can be provided.

### SUMMARY OF THE INVENTION

Various aspects of the invention are defined in the independent claims. Some preferred features are defined in the dependent claims.

According to the present invention, there is provided a system and method for detecting objects that encroach upon an underwater region, considered typically as an elongated spatial region, referred to herein as an “underwater detection fence”. The word fence is adopted to refer to a region or regions and associated structures having the ability to detect the presence of an intruding object. The detection principle is based on disturbance of electromagnetic signal transmission characteristics caused by a target object, which intrudes upon a region between a transmitting point and a receiving point.

The present invention relates to methods and systems for implementing a multi-span fence network. The spans may operate simultaneously. Using multiple spans allows the area to be protected to be fully enclosed or to greatly extend the range of monitored area by concatenation of fence spans. Multi-element fence networks also improve the ability to define the location of a detected object since detection will usually be limited to detecting the object's presence within a defined span.

The multi-element fence is operable to detect objects autonomously without provision of an external reference signal. Object detection is based on comparison of present received spectrum characteristics against an established reference spectrum derived from a previous time period.

The system detects the presence of objects by identifying changes in the electro-magnetic signal path between two transducers caused by the object as it moves into the volume of water traversed by the signal.

The system provides sufficient range, resolution and speed to be able to protect assets from undetected approach underwater. It incorporates features to allow many transducer pairs to be used so that an extended area can be covered, allowing the object to be located within defined zones.

At the receiver, the resulting electrical signal is analysed to obtain the spectrum of the signal. The spectrum is the basis for detection of objects interrupting the signal path.

Two or more elongated fence regions may be provided. If required these regions can be deployed to encircle and entirely enclose a zone or volume of water to be protected. A chain of transmitters and receivers may be concatenated to form and define a perimeter of the region to be protected.

### BRIEF DESCRIPTION OF THE DRAWINGS

Various aspects of the invention will now be described by way of example only and with reference to the accompanying drawings, of which:

FIG. 1 is a diagram of a single span of an electromagnetic security fence deployment;

FIG. 2 is a set of three typical graphs of baseband power spectral density showing a signal as transmitted, a signal as received without intruder disturbance, and a signal received with intruder disturbance;

FIG. 3 is a diagram showing the architecture of a single span of a frequency division based system;

FIG. 4 is a schematic diagram of a spread spectrum transmitter for use in a detection fence;

FIG. 5 shows a block diagram representation of a spread spectrum receiver and detection mechanism;

FIG. 6 is a diagram showing two possible deployments of a security fence;

FIG. 7 shows a detection system design based on separate transmitter and receiver nodes;

FIG. 8 shows a transceiver based detection system design,

FIG. 9 shows a crossed antenna structure for achieving isolation during simultaneous transmit and receive at a transceiver;

FIG. 10 is a schematic diagram of a device, based on the commonly known telephone hybrid, which can fulfil the functional requirements of a transmit and receive signal diplexer, and

FIG. 11 is a diagram of an extended security fence.

### DETAILED DESCRIPTION OF THE INVENTION

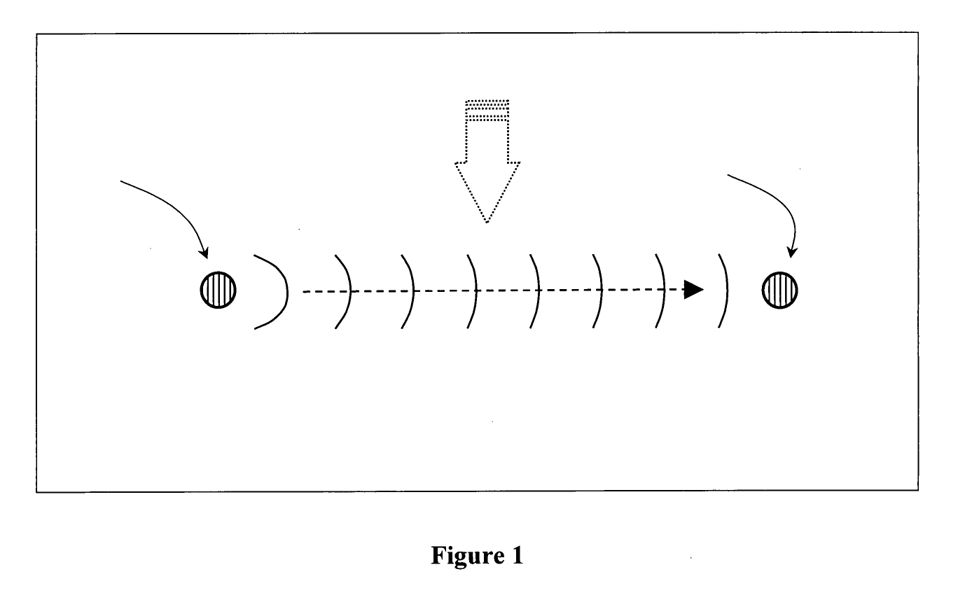

FIG. 1 shows one span of a multi-span security fence that has a transmitter with a transmit antenna 1, which is submerged in water, and a receiver with a receive antenna 2, also submerged. The region between the transmitter and receiver forms an elongated fence 3. The antenna may be of any suitable form, for example a magnetic coupled antenna, preferably based on loops or solenoids. The solenoid may be formed around a high magnetic permeability material. The insulated antenna may be surrounded with a low conductivity material with permittivity matched to that of the propagation medium e.g. distilled water. A signal emanating from the transmit antenna 1 passes through the region of the elongated fence 3 and is detected by the receive antenna 2. The transmitter operates continuously. By monitoring the received signal, perturbations or changes caused by the presence of an intruder 4 can be detected.

It will be understood that the wave does not propagate along a direct narrow line from transmitter to receiver but comprises an electromagnetic propagating and/or magneto-inductive field which fills a large volume around its direct end-to-end path; so that the wave will be influenced not only by water on a direct path between the transmitter and receiver, but by nearby surroundings.

The underwater detection system has two distinct functions. First it must implement an effective detection mechanism but secondly it must communicate to deliver timely information regarding the position, movement and characteristics of a submerged object to some control centre to allow development of an appropriate reaction.

The detection mechanism uses spectral broadening of the recovered baseband signal after transmission through the medium. A detection threshold frequency is defined and the power measured above that frequency taken to indicate the level of disturbance to the signal path. Spectral analysis of the signal yields characteristic signatures for objects of different material, size and speed.

Propagation velocity decreases as conductivity increases. Changes in conductivity introduce significant changes in propagation velocity. There may be some variation in seawater conductivity but the water will usually be effectively homogeneous within the signal path. Changes resulting from an object present in the path will introduce velocity changes and hence phase changes in the received signal.

Any object that significantly changes the conductivity for part of the signal path will produce a change in signal attenuation.

Receiver elements within a fence network must be able to separately analyse signals transmitted from multiple sources to enable correct identification of the span in which the detected object is present. This requirement will lead to the duplication of the receiver circuit within a single receive node to implement a “dual receiver” which can simultaneously process signals from two separate transmitters. Each receiver must be able to analyse the signal from a specific transmitter and reject the signals, which will be generated from other transmitters in the system. There are several possible multiplexing techniques, which are applicable for this requirement. Frequency division and code division implementations will be described here. A first method uses frequency division based on narrow spectral tones generated at a unique frequency at each transmitter node. A stable electromagnetic signal, assumed for simplicity in this description to be a continuous single sinusoidal wave, is transmitted through a region of water where object detection is desired, and received by a distant receiver. At the point of transmission the signal can be arranged by well-known generation methods to be very pure. That is to say, as will be understood by those familiar with generation and analysis of signals, it can be considered as a carrier wave with such a low level of incidental unwanted modulation that its spectrum is extremely narrow.

Upon reaching the distant receiver, analysis of the spectrum of the signal usually will show it to have become somewhat degraded, even in the absence of a foreign object in the region of the path of the signal. The spectrum, previously with its power confined to a very narrow frequency band, will typically show signal energy distributed over a slightly widened region about the central carrier frequency. Although small in magnitude, this effect is equivalent to a degree of modulation of the previously pure carrier wave. This arises because of the changing nature and surroundings of the region of water transmitting the signal. Expressed in conventional mathematical terms well known to those familiar with signal analysis, it may be said that the vector representing the signal includes small but measurable perturbations in amplitude and phase from its nominal behaviour.

The degradation of the originally pure sinusoidal wave arises because of the presence of one or more of several possible propagation effects associated with the water and its boundaries. These include temporal influences such as: movement of the water; changing distance from reflecting surfaces (sea shore, sea bottom, sea-air surface and nearby objects not quite static) whose presence and varying positions contribute not only propagation paths for additional interfering signals but introduce Doppler frequency shift to these signal components; similar changing discontinuities in the electromagnetic properties of water due to adjacent masses of water exhibiting slightly different salinities and temperatures resulting in different conductivities and consequent refraction and diffraction; tidal and other movements of the water which alter its salinity and hence conductivity, giving rise to changing propagation velocity; and incidental small changes in distance between transmitter and receiver, and in the orientation of their antennas. Typical perturbing effects such as these introduce perceptible changes to the spectrum as detected at a receiving point, which must be distinguishable from an intruder detection spectral signature.

Alterations to the spectrum may include the appearance of some or all of the following components: amplitude and delay changes to the central carrier, addition of sideband power with paired components symmetrically disposed about the carrier and with symmetrical phase, addition of sideband power with paired components symmetrically disposed about the carrier and with asymmetrical phase, addition of new signal components slightly offset from the carrier. As will be familiar to those skilled in the mathematics of signal analysis, amplitude and/or phase modulation of a carrier can be considered as alternative but equivalent ways of describing the same spectral phenomena. This means that, if simpler for design implementation, it often will be convenient to measure changes in amplitude and phase of the aggregate signal directly rather than assessing the power spectral density of signal components about the central carrier, but both measurements may be performed and utilised.

If nothing is present in the signal path the receiver will observe a pure sinusoidal signal and obtain a characteristic impulsive spectrum. As an object moves into the signal path it causes changes the amplitude and phase of the received signal. When the changing signal spectrum is analysed, a different signature is obtained and the signal is seen to be no longer a pure sinusoid. The additional terms present will depend on the nature of the target, its speed and its location between the transmitter and receiver. The baseband signal spectrum will be characteristic of a particular target.

With no object present in the signal path, a receiver will be able to measure the spectrum and observe the pure tone signature characteristic of the clear signal path. When an object is introduced into the path, a change will be evident in the spectrum of the signal as measured by the receiver. The amplitude and phase of the received tone will change due the presence of an object because it introduces a variation to the conductivity, permeability or permittivity of the material in the signal path. Any object with different properties to seawater will case such a disturbance. A moving object will introduce spectral components in addition to the pure carrier signal that can be detected by spectrum analysis. A stationary object will modify the spectrum amplitude compared to a defined pre-detection reference spectrum.

Although changed from the pure signal transmitted, the resultant spectrum of the received signal can be considered a normal characteristic for any particular deployment environment at a defined time period and may be measured by signal analysis methods, typically digital, well known to those skilled in this field. The shape of the normal characteristic is accurately measured and recorded by analysis functions in a receiver and may be updated very gradually to accommodate slow changes over long periods of time in the order of minutes. This measured characteristic is used by a receiver as a reference against which unusual disturbances arising from the intrusion of an object can be detected by observing resultant changes that are sufficiently significant not to be accounted for by usual marine movements. A small submarine, for example, will change the field by scattering, diffracting and absorbing signal energy so that the received spectral characteristic will be altered markedly if it encroaches upon the elongated region between transmitter and receiver. Thus the region between transmitter and receiver can be considered as a form of intruder detection fence. The received signal is analysed and its spectrum compared with that received in the absence of an intruder. When spectral differences of notable magnitude are found to occur, it is inferred that an object of significance has intruded upon the region of the fence.

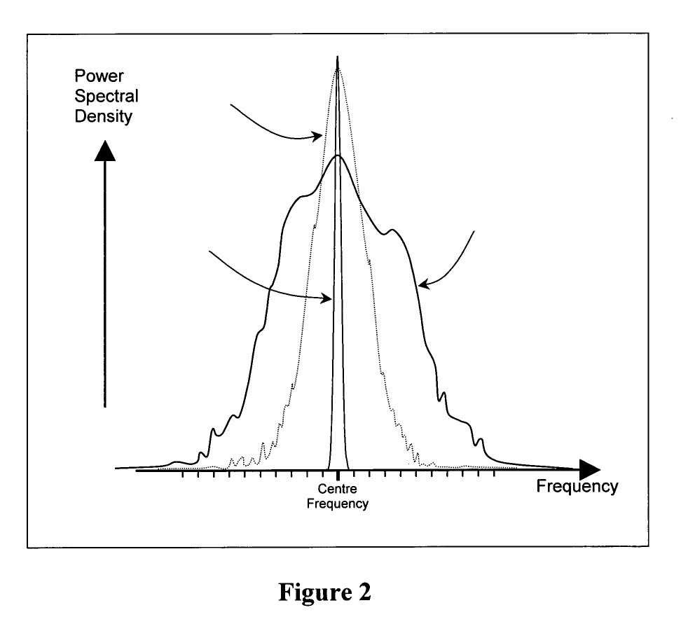

FIG. 2 shows a spectral plot 5 representing a transmitted signal of a typical degree of purity. After transmission in water through the region of the fence and in the absence of an intruder, the signal picked up by the receive antenna and coupled to the receiver will show some spectral widening as represented typically by spectral plot 6. The precise frequency width and shape of widened spectrum 6 will depend upon disturbances, which the electromagnetic and magneto-inductive field of the signal has experienced in illuminating the region of the fence. Irrespective of its precise form, the receiver is operative to measure and record the shape and level of the spectrum, and to remember or store that shape and level for use as a future operational reference. This shape and level may be referred to hereinafter as the “reference spectral shape”, or the “reference shape”.

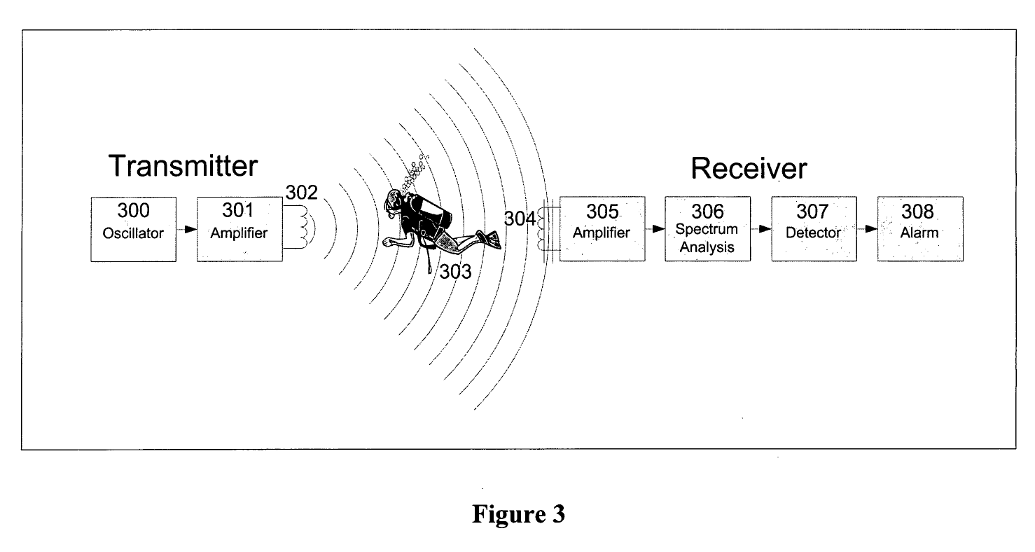

FIG. 3 shows a block diagram of a single fence span in a multi-span system based on a frequency division multiplexing technique. Oscillator 300 generates a low phase noise tone, which is amplified by amplifier 301 and radiated into the water by antenna 302. Object 303 modifies the spectral characteristics of the signal during its passage through the water and the signal is received by antenna 304. Amplifier 305 raises the amplitude of the received signal, which is analysed by Spectrum analysis function 306. Spectrum analysis function 306 is able to separate signals from different transmitters based on their frequency. Detector 307 analyses the received spectrum to determine an alarm condition, which is signalled by alarm block 308.

To achieve the necessary fine frequency resolution of the spectrum, analysis of the signal should take place over a considerable period of time, typically several tens of seconds or more. Typically it will be satisfactory to assess the spectral shape by measuring the received signal amplitude at frequency intervals of no less than 0.1Hz around the central carrier frequency. However, still finer resolution of the shape may allow implementation of a more sensitive detection system, and may be desirable in some applications. The resultant set of amplitude measurements, usually expressed as a set of numbers, serve to define the measured shape of the spectrum. If the environmental conditions giving rise to the spectral widening are subject to slow change, a receiver in a preferred embodiment of this invention will gradually and continually update the numbers representing the reference spectral shape to reflect current conditions experienced by the signal. Such an updating process can comprise some form of moving average of each of the spectrum characteristics and will require a considerably longer updating time constant, typically several tens of minutes. Methods of measuring and recording the reference spectral shape are well known to those skilled in spectrum analysis, and may advantageously adopt the techniques of digital signal processing.

In FIG. 1, if an object 4 intrudes into the fence region 3 illuminated by the field, then the spectral shape detected by receiver 2 changes. In FIG. 2, spectral plot 7 represents a possible changed spectrum that may arise in the presence of an intruding object. The precise shape of the altered spectrum depends on the intruding object: including its size, position, orientation and velocity, and the electrical and magnetic properties of its constituent and surface materials. Periodic measurements of current spectral shape conducted by the receiver are compared with the reference spectral shape. When a comparative change is found, the presence of an intruding object is inferred by a comparison function in the receiver, whereupon the receiver will initiate a series of alarm operations to bring attention to the suspicious event by an operator or trigger some automatic defensive system.

Under normal quiet conditions in the assumed absence of an intruder, the signal processor gathers signal data over a sufficiently long period to allow fine resolution of the received spectrum shape, as previously outlined. This may be achieved by a number of equivalent methods. Direct filtering by an array of many narrowband filters covering the region around the centre frequency of the carrier may be employed, or an equivalent procedure, which effectively achieves many narrowband filters may be adopted. As another alternative, a time to frequency transformation of a sequence of received signal samples may be used to calculate the spectrum at a range of closely spaced frequency points. Transforms from the time to the frequency domain for this purpose may, for example, utilise the well-known discrete Fourier transform, but others are also possible. The frequency spectrum resulting from this analysis captures the reference signal spectrum indicative of the normal water environment in the absence of an intruding device. To accommodate possible very slow changes in the normal situation, and in preferred embodiments of this invention, it usually will be desirable to maintain a reference spectrum, which adjusts gradually by computation of a long-term average on a continuous basis. Methods of digital signal processing to accomplish one or many narrowband filters and/or time to frequency domain transformation are well known to those skilled in the art of signal theory and practice.

The sensitivity of the system to small objects and objects moving through the fence at a range of speeds is determined by a number of features of the system that must be optimised to achieve good performance. In addition, a number of features are required to allow a workable system to be constructed (such as channel coding) that must not significantly interfere with detection performance.

Transceiver units must be spaced to allow a good signal to noise ratio to be achieved at the receiver. This is essential for the detection of small disturbances and therefore good detection sensitivity. This requirement has a bearing on the frequency of radiation used as attenuation of electromagnetic waves increases with frequency in seawater.

In a conductive medium the attenuation at a distance of one wavelength is approximately 55 dB. The requirement for a strong signal means that the wavelength at the chosen frequency of operation will typically be of the same order as the operating distance between transmitter and receiver. In seawater deployments the carrier frequency will typically be less than 100 kHz. The partially conductive nature of seawater greatly reduces the wavelength of a propagating electromagnetic wave. The wavelength at 100 kHz is 5 m for typical seawater with conductivity of 4 S/m compared to over 3 km wavelength in air.

Since fence node spacing is typically similar to the through water wavelength it will be evident that the detection area is not concentrated along a direct line connecting transmitter and receiver as might be anticipated from a “beam” type system but rather takes the form of a diffuse field enclosing a significant volume of water between transmitter and receiver. Detection will be strongest at the centre of this region but the off-axis limits of the elongate detection volume will be defined by the ultimate sensitivity achieved by the system implementation as a whole.

Preferably, the transmit antenna 1 in FIG. 1 and the receive antenna 2 are electrically insulated, magnetic coupled antennas. By using such magnetically coupled antennas in the fence, lower transmission loss is gained over conventional electromagnetic antennas of the types commonly used in air or free space. Preferably, very low signal carrier frequencies are used, and may be in the range of 100 Hz to 100 kHz. Frequencies in the range of 1 kHz to 10 kHz are ideal. The nature and advantages of electromagnetic and/or magneto-inductive signals and of magnetic antennas for communication through water are discussed in our co-pending patent application, “Underwater Communication System” PCT/GB2006/002123, the contents of which are hereby incorporated by reference.

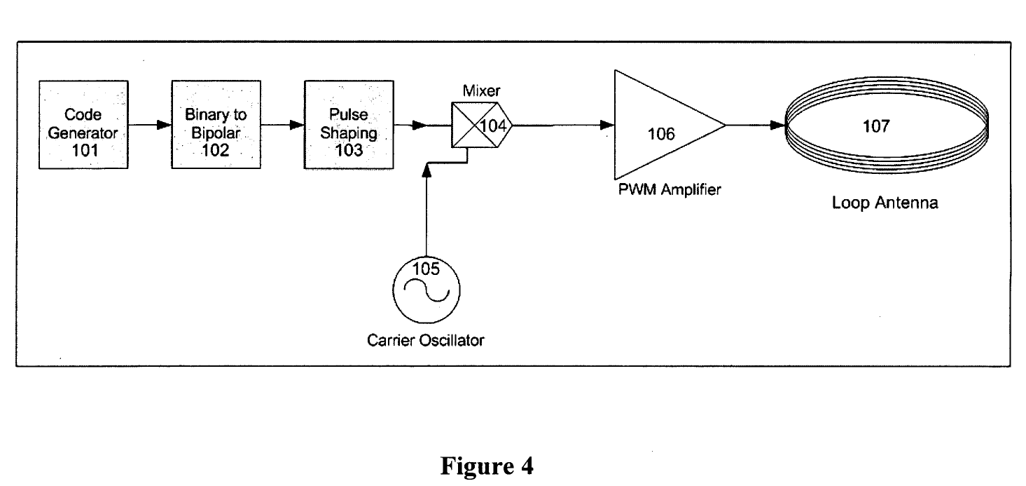

Code division is a second multiplexing method applicable to a multi-span detection system. A similar detection method is applicable but a wider bandwidth signal is radiated through the water. FIG. 4 shows a block diagram of the intended transmitter architecture. The transmitter consists of a code generator 101, which generates a binary code bit stream. The binary code stream is converted by 102 to a bipolar bit stream then filtered in pulse shaping component 103, which defines the occupied bandwidth of the base band signal. Mixer 104 combines the baseband signal with a carrier signal produced by oscillator 105 and produces a phase-modulated carrier. This is then applied to a power amplifier 106 that uses a pulse width modulation (PWM) technique to efficiently generate the required current in the transmit antenna 107.

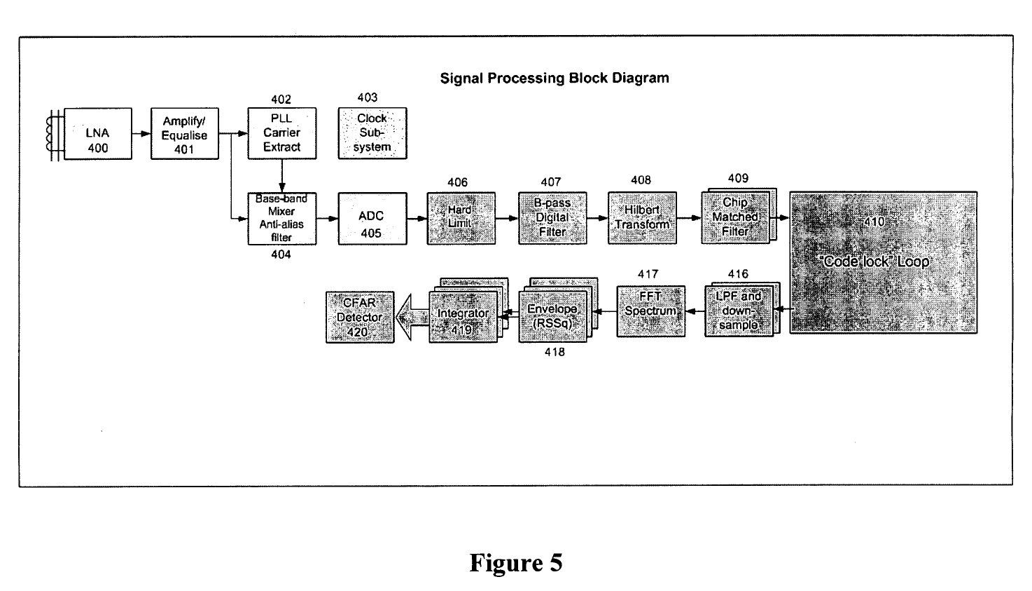

FIG. 5 shows a block diagram of one possible implementation of the detector signal processing chain. The receiver makes use of analogue and digital signal processing to achieve two objectives: selection of signal from one transmitter by means of code division multiplexing and detection of objects in the signal path between transmitter and receiver by identifying changes in the received signal spectrum.

Signal is received from the antenna by a low-noise differential amplifier 400, that is followed by and equaliser and amplifier 401. A narrow band phase locked loop (PLL) 402 is used to reconstruct the carrier, and the recovered carrier is mixed 404 with the signal to recover the base-band signal and an anti-alias filter applied 404. An analogue to digital (ADC) converter 405 is used to digitise the base-band signal. This digitised representation of the signal is routed to a Digital Signal Processing device, which performs complex signal analysis tasks. The digital signal processing commences by hard limiting 406 the signal. This introduces a measure of immunity to impulsive noise. A band-pass filter 407 is applied and a Hilbert transform 408 is used to generate I & Q components.

A code-locked loop 410 is used to synchronise the receiver to the required coded channel and the decoded signal is further filtered 416 to reduce the bandwidth allowing the sample rate to be decreased. This stage represents a departure from the standard implementation of a code division multiple access communications system. In this detection application the code locked loop 410 extracts an un-modulated carrier signal from the spreading code for spectral analysis and hence object detection. In comparison, a communications system extracts the code content of the received signal and aims to reject any phase or amplitude modulation of the carrier.

Spectrum analysis is performed by means of a fast Fourier transform 417 and the frequency bin outputs are envelope detected 418 and integrated 419 and the signal passed to a constant false alarm receiver detector 420.

Propagation velocity increases with frequency. This becomes important when a signal carrying modulation, such as code division multiplexing, is used as the different frequency components will propagate at different speeds introducing dispersion to the signal. This dispersion can be corrected using equalisation techniques well known to those skilled in telecommunications technology.

In water, electromagnetic attenuation increases with increasing frequency. Operational range is maximised by minimising carrier frequency. Detection time is minimised by increasing the occupied bandwidth of the signal. These system design considerations lead to the implementation of a wide occupied bandwidth at a low carrier frequency i.e. maximised bandwidth to carrier ratio. This requirement results in antenna design challenges.

Details of a beneficial antenna design which achieves this purpose are discussed in our co-pending patent application, “Antenna formed of multiple resonant loops”, GB0724692.9, the contents of which are hereby incorporated by reference. This invention relates to electromagnetic and/or magneto-inductive antennas formed of multiple separate conducting loops which are resonantly tuned and loosely coupled together for increased antenna operating bandwidth. This type of antenna will be referred to hereafter as a “multi-resonant loop”.

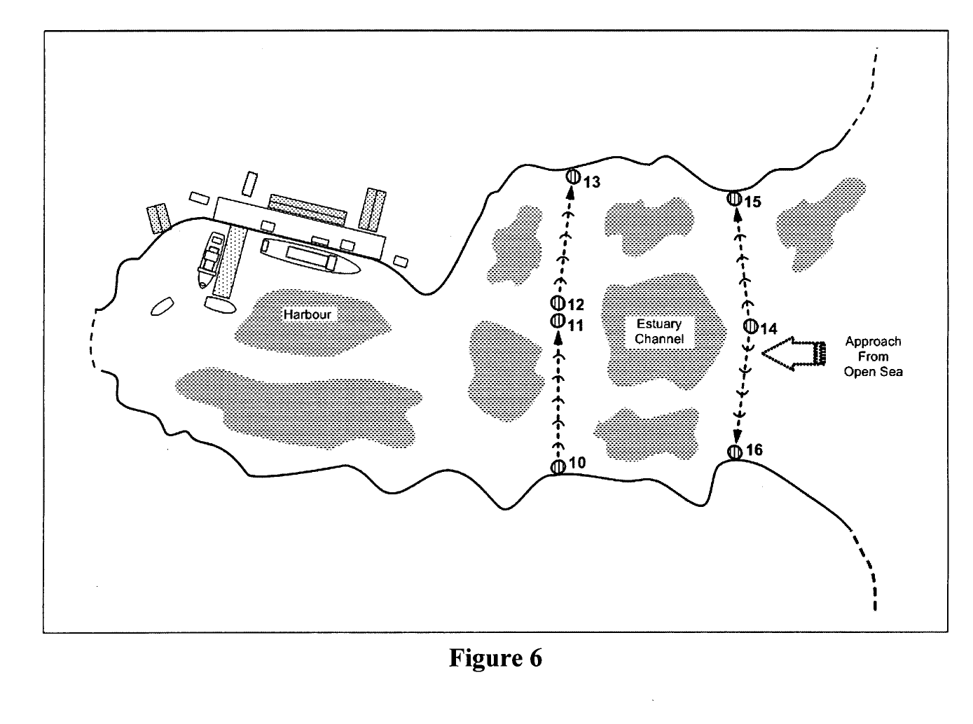

FIG. 6 shows a sensitive harbour to be protected that is situated within a typical estuary inlet of the sea. Two of the many possible ways in which a multi-span security fence according to this invention may be arranged are shown. The first case has two independent sections of fence, comprising a first fence span between transmitter 10 and receiver 11, and a second span between transmitter 12 and receiver 13, such that receiver 11 and transmitter 12 are situated somewhat in the middle of the estuary channel and sufficiently close to each other to avoid a vulnerable gap. The requirement for co-location leads in practice to 11 and 12 being implemented as a transceiver device. This arrangement can be extended readily to further sections if required. In the second case, the fence again has two sections, but transmitter 14 is placed somewhat in the middle of the channel to act as a common signal source for both the receiver 15 and the receiver 16 simultaneously.

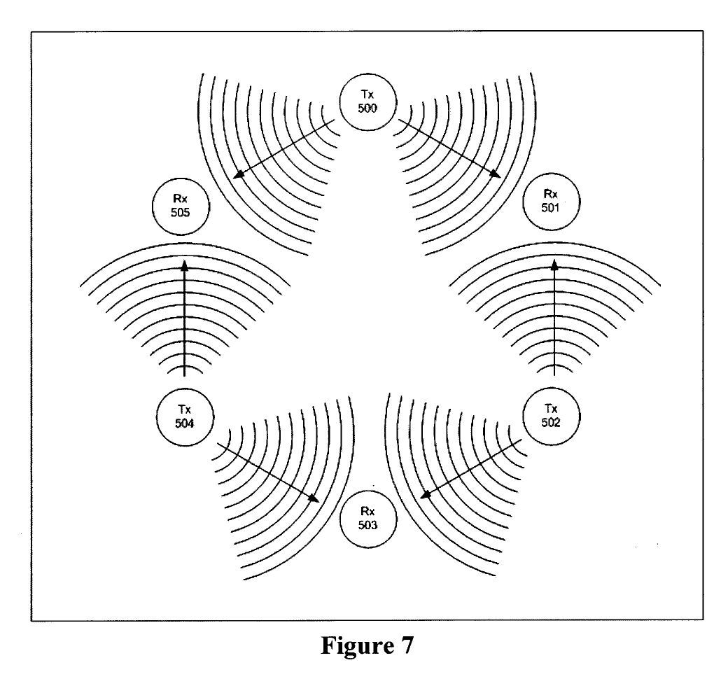

FIG. 7 shows an example system configuration for a transmit to receive architecture multi-span fence system. Nodes of the fence alternately implement transmit or receive functions. Each transmitter generates a signal, which radiates a three dimensional amplitude pattern defined by the antenna characteristics but in any case radiates significant power in the direction of the two adjacent receivers. Each receive node implements two independent receivers and signal processors which each analyse the signal received from a single transmitter using one of the described multiplexing techniques. In this architecture, receivers only require separation of several received signals of similar amplitude compared to a transceiver-based architecture, which must also provide isolation from an integrated transmitter.

Transmitter 500 generates a radiated signal, which is received and analysed by receivers 501 and 505. Receiver 501 must also have a separate channel to analyse the signal from transmitter 502 and must be able to distinguish and independently analyse signals received from the two adjacent transmitters 502 and 500. Receiver 503 similarly analyses transmit signals from transmitter 502 and 504. Receiver 505 monitors signals from transmitters 500 and 504 and in this way contiguous perimeter coverage is achieved around an enclosed area.

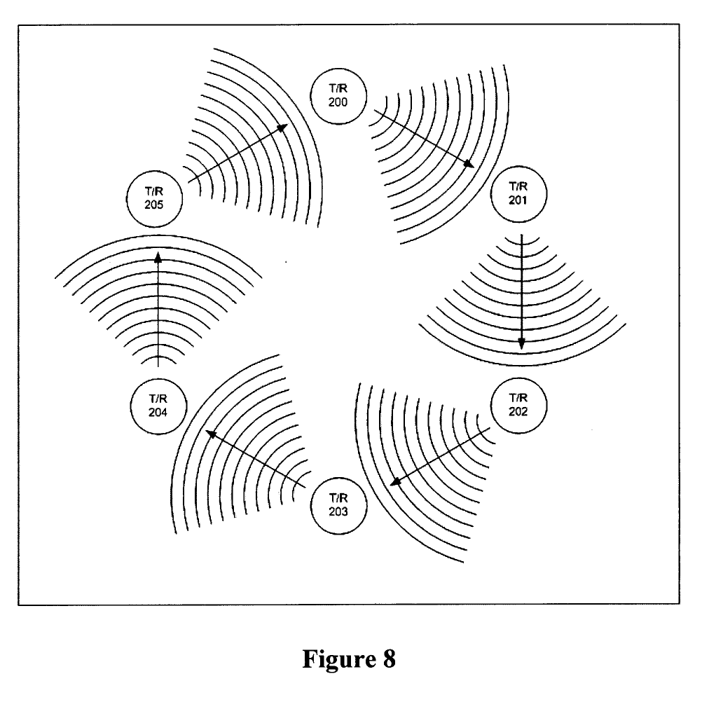

The transceiver based multi-node fence architecture of FIG. 8 represents an alternative system architecture, which presents both additional features and design challenges to overcome. The transceiver based architecture main system benefits result from the ability of each node to send and receive control and configuration information around the multi-node fence. Each node can also act as a means of communicating an alarm event or detected object characteristics to other nodes or to a remote monitoring station. The spreading coding can also be used to communicate information along the fence chain.

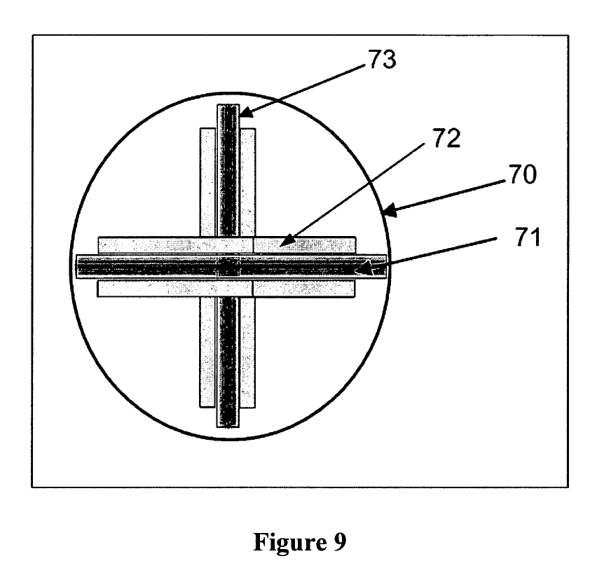

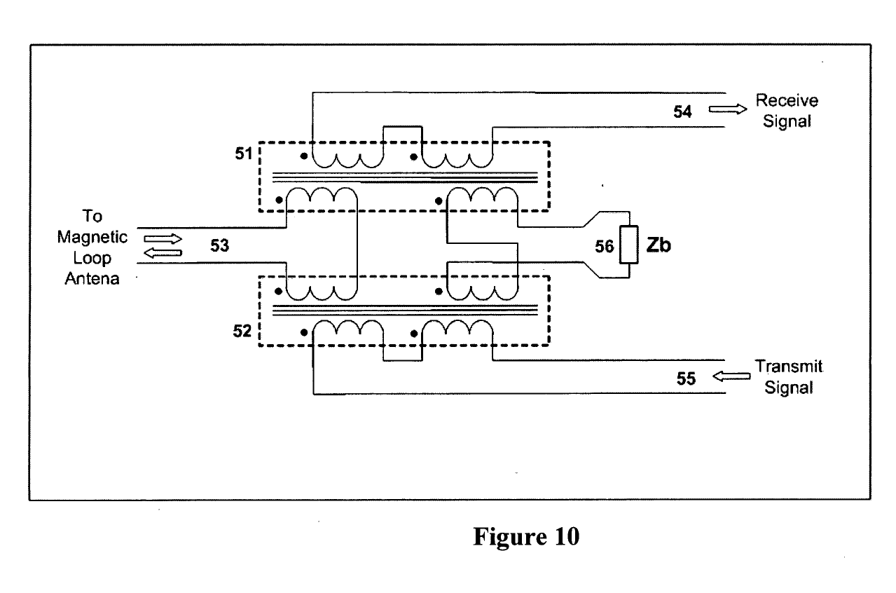

FIG. 8 illustrates an example transceiver based circular system deployment. Transceiver 200 generates a radiated signal, which is received and analysed by transceiver 201. 201 transmits to a receiver at 202 and the chain continues in this way through transceivers 203, 204, 205 and returns to the receiver at node 200. This architecture adds the requirement of isolating the receiver from a co-located transmitter to a degree that allows reception of the attenuated signal from an adjacent transceiver without significant distortion. The required isolation is achieved through the adoption of three additive measures. First the co-located T/R antenna of FIG. 9 is employed to reduce transmit signal coupled from the transducer. Second the hybrid structure of FIG. 10 is used to provide circuit isolation and thirdly a code division scheme is used to provide additional coding isolation by running an orthogonal coding scheme in the associated transceiver transmitter and adjacent transmitters.

The system consists of a number of transceiver units each capable of generating a signal and launching it into the surrounding water and simultaneously receiving a signal through the water from an adjacent transceiver unit. The signals are coded to allow signals from a specific transceiver to be identified and this coding defines the signal bandwidth at the point of interaction with the detected object. By modulating the signal on each section with binary or other coded, mutually orthogonal data patterns, interference can be diminished. For example, phase modulation could be used. Thus it is ensured that each receiver reacts substantially only to the signal from its appropriate transmitter, because orthogonality of the signals and correlation in the detection process ensure that at each receiver all unwanted signals result in negligible output from the detection process. The choice of suitable orthogonal signal patterns, and their nature and treatment, are well known to those skilled in communication engineering.

Each fence node may implement a transceiver function. To remove the opportunity of an object passing through the fence undetected it is desirable to achieve continuous detection coverage in time. For this reason, each node must transmit and receive simultaneously. We must achieve isolation between a transceiver's transmitter and receiver. Our co-pending patent application, “Co-located Transmit-Receive antenna system” GB0724703.4, the contents of which are hereby incorporated by reference, relates to the design of a co-located antenna system which is simultaneously optimised for transmit and receive performance. The transmitter and receiver antennas are co-located with the receive antenna orientated so as to minimise reception of signals radiated by the transmitter. This type of antenna is beneficially utilised at each node of a transceiver-based architecture. FIG. 9 illustrates the mechanical alignment envisaged in the antenna design that will be referred to hereafter as a “co-located antenna”.

FIG. 9 illustrates the geometrical alignment of the crossed receive solenoids 71, 73 and transmit loop 70. Receive solenoid coils are represented in cross section by the shaded sections 72. Many turns of wire, are wound around high permeability core 71 and 73. Multi-turn transmit loop 70 generates lines of flux coming out of the page so does not saturate the receive coil. Receive coil 71 and core 72 are designed in terms of permeability, length to diameter ratio, number of turns and position of turns on the rod using principles well known to practitioners skilled in the art of low frequency radio antenna design and will not be repeated here since the design decisions are un-modified by the mechanical arrangement which is the present subject of this invention. Similarly the number of turns used in the transmitting loop will be selected dependent on the available driving Voltage and the material of the wire loop to maximise the current * turns product. As a first stage in the receiver design signals from the two crossed receiver solenoids must be combined. Crossed solenoid receiver antennas combined in this way provide relatively uniform reception in the plane of the transmit loop.

The system may include a transmitter and receiver at the same location. The co-located transmitter and receiver may operate in a manner similar to a hybrid telephony device. This uses separate transmit and receive signals at a common antenna or a pair of antennas in proximity. This can be advantageous, because when transmitting and receiving at the same place on the same frequency, the very strong transmitter may swamp the small receive signal. Using a “hybrid” device is one way of achieving the necessary isolation.

FIG. 10 shows an example of a diplexer that could be used to provide transmit to receive isolation in a transceiver design. It will be appreciated that any suitable device may be used provided it can cancel or balance out the transmitted signal to prevent any substantial component reaching the receiver input and prevent a received signal leaking into the transmitter amplifier. This is a version of a device otherwise well known in telephony applications as a hybrid used to interconnect so-called 2-wire and 4-wire telephony transmission systems. As will be understood, the arrangement depends on careful signal balancing and cancellation to achieve effective operation, a condition that relies in turn on the connection of appropriate impedances at the four ports 53, 54, 55, 56 and on the number of turns on the two transformers 51, 52. Power from a transmit signal applied to port 55 is directed to port 53, ideally with little or no residual power leaking to port 54. This latter requirement is important to avoid a small receive signal at port 54 from being hidden by an unwanted component of the transmit signal. Power applied to port 53, in this application a signal received by the antenna, is directed to port 54, and ideally no power is directed to port 55. If the two transformers 51, 52 have windings of equal numbers of turns and polarities shown, and the correct balancing impedance (Zb) is connected at port 56, then the hybrid will direct signal power as required, fulfilling the diplexer requirements of this invention. Some power is lost by dissipation in Zb.

In practice, the impedances at ports 53, 54, 55 may not be known with sufficiently high precision to allow the required exact choice of impedance Zb, although its approximate value may be calculated. Accordingly, a small adjustment of the value of impedance Zb usually will be required (in both its resistive and reactive components) when in the deployed environment to achieve balance with the necessary precision. This is accomplished in deployed operational situations by an electronic adjustment control loop (not shown) which varies the resistive and reactive parts of Zb such as to achieve balance as indicated by a minimisation of the unwanted residual transmit signal power finding its way to port 54. Methods suitable for achieving this condition are well known.

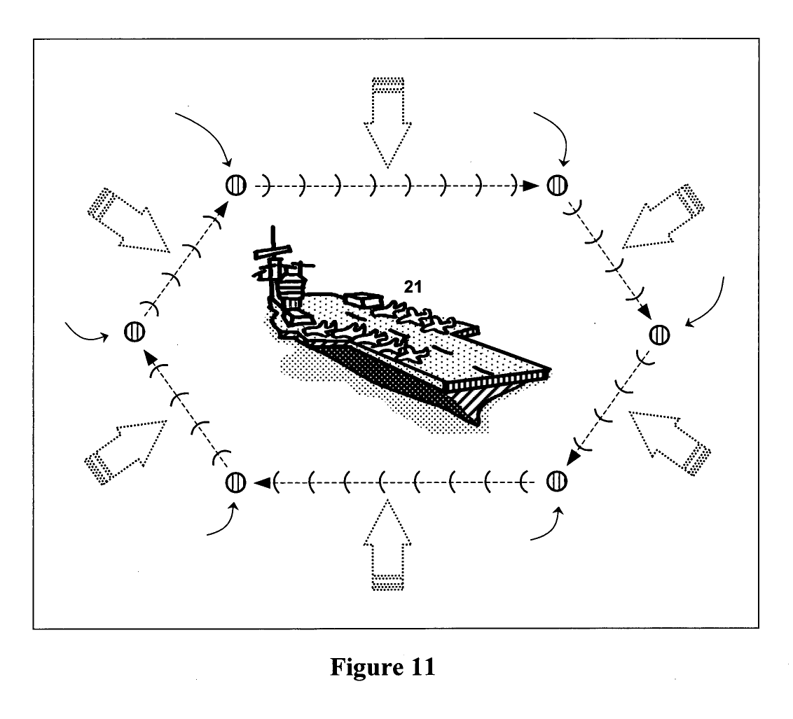

FIG. 11 shows another fence arrangement. In this a set of detection fences defined by a series of nodes with associated transmitters and corresponding receivers encircles an area that has to be protected. Although six nodes are shown, it will be appreciated that any number of nodes more than three could be used. The encircling fence can provide a secure central zone to protect, for example, a high value asset such as an aircraft carrier 21. A transmitter within node 22 transmits to a receiver within node 23, which in turn contains a transmitter which transmits to a receiver within node 24, and so on around the series of nodes 25, 26, 27, with a transmitter within node 27 which transmits to a receiver within node 22, thereby completing the encircling fence.

In addition to determining the reference spectrum, the signal processor continually examines the current received spectrum and, in particular, performs a comparison of this with the reference in order to infer the presence of an object intruding upon the region of the fence. Where differences in spectra are found to exceed a value large enough to avoid false conclusion due to small anomalous perturbations, the presence of an intruding object is assumed. Digital signal processor may be one of many readily available commercial devices, and should be supplied with an analogue to digital converter at its signal input and a digital to analogue converter at its signal output.

Dependent on operational requirements, the detection of an intruding object usually will be communicated by some method as an alarm to an appropriate authority or equipment so that action may be taken if required. Communication of the alarm condition may be achieved by a variety of means including a wired cable (not shown) from the detection nodes to equipment in the vicinity of the authority; through the use of an acoustic modem or through radio modem links. In another method, a predetermined extraordinary modulation (or some other) signal may be sent by one or more of the transmit nodes so that it can be detected and interpreted by an alarm receiver (not shown) equipped for the purpose, whence the alarm condition can be conveyed to the authority. The receiver may be equipped with a magnetic antenna similarly to those of the detection nodes, or some other communication method adopted. Advantageously, the alarm condition is transmitted using the same equipment used for detection.

Each node of the fence is associated with a radio modem for communication of alarm and detected object characteristics. The nature and advantages of electromagnetic and/or magneto-inductive signals and of magnetic antennas for communication through water are discussed in our co-pending patent application, “Underwater Communication System” GB0511939.1, the contents of which are hereby incorporated by reference.

Where sections of fence comprise a chain, a node may alert other nodes to the alarm condition by sending a special predetermined modulated signal or code for the purpose, which is then repeated or conveyed by other nodes down the chain of nodes. This has the advantage that all nodes, or at least more than one node, transmits the alarm condition to an alarm receiver and thereby maximises alarm signal power for the purpose. In some implementations of this invention, it may be advantageous for differently coded modulation signals to be used by each section of fence so that the authority can be informed of the location of an intruder according to the code received.

A synchronising signal may be distributed between detection nodes by means of a cable. A connecting cable complicates deployment but in some instances this may be acceptable. The cable carries a single clock frequency, which is used as an invariant frequency and phase reference for each receiver in the system. A clock reference distributed by cable will provide a constant reference for comparison with a signal, which is radiated and passes through the detection volume of water. Variation of the received radiated signal with respect to the cable reference signal will form the basis of object detection in this instance. A cable connecting each node of the fence can also effectively implement communication of an alarm event or detected object characteristics.

Although example applications given hitherto are illustrated by the protection of assets in large areas of water, it will be understood that the principles disclosed in this invention may be adapted without loss of principle for detection of other objects including, for example but not exclusively, fish moving through a monitored region, vehicles or persons penetrating a region, and foreign objects carried in moving water. Furthermore, the detection methods of this invention are not restricted to underwater environments, and may equally be deployed to detect objects that are partially underwater, floating on water, carried in or by water or other fluid or not in water or other liquid.

Also, whilst the systems and methods described are generally applicable to seawater, fresh water and any brackish composition, because relatively pure fresh water environments exhibit different electromagnetic propagation properties from saline, seawater, different operating conditions may be needed in different environments. Any optimisation required for specific saline constitutions will be obvious to any practitioner skilled in this area. Accordingly the above description of the specific embodiment is made by way of example only and not for the purposes of limitation. It will be clear to the skilled person that minor modifications may be made without significant changes to the operation described.

1. An underwater detection system comprising: at least one transmitter located at a transmitter node for transmitting electromagnetic and/or magneto-inductive signals through water; at least one receiver located at a receiver node for receiving said transmitted signals; a signal processing device which monitors said received signal, and compares said monitored signal with a monitored signal from an earlier point in time said comparison of said monitored signals enabling the identification of a change in said received signal.

2. An underwater detection system as claimed in claim 1 further comprising multiple transmitters for transmitting electromagnetic and/or magneto-inductive signals wherein each of said multiple transmitters is associated with a different detection region.

3.-5. (canceled)

6. An underwater detection system as claimed in claim 2, wherein said detection regions combine to form a security fence.

7. An underwater detection system as claimed in claim 6 wherein said security fence encircles a defined protection region.

8. (canceled)

9. An underwater detection system as claimed in claim 2, wherein said transmitted signals are modulated by mutually orthogonal data patterns or use other orthogonal signal properties in at least two different detection regions.

10. An underwater detection system as claimed in claim 2, wherein said transmitted signals in at least two different detection regions are transmitted at separate frequencies.

11. An underwater detection system as claimed in claim 1, wherein said at least one receiver includes a digital signal processor for at least one of signal detection, signal filtering, time to frequency transformation, spectrum analysis, signal generation, modulation, and locking a signal in phase.

12. An underwater detection system as claimed in claim 2 further comprising a signal identification means in at least two of said multiple transmitters, for including in said transmitted signals an identifier that is recognisable by at least one associated receiver.

13. (canceled)

14. An underwater detection system as claimed in claim 2 further comprising a modulation means for phase modulation of a transmitted signal from at least one of said multiple transmitters.

15. (canceled)

16. An underwater detection system as claimed in claim 1 further comprising a communication means for communicating detection information to a remote monitoring station.

17. An underwater detection system as claimed in claim 1, wherein each receiver and transmitter is co-located with a corresponding transmitter or receiver to define a transceiver node that performs a transceiver function.

18. An underwater detection system as claimed in claim 17 wherein transceiver nodes alternately perform transmit and dual receiver functions to process signals from two adjacent transmitters as they are deployed along an integrated fence system.

19. An underwater detection system as claimed in claim 17 wherein each transceiver node has a co-located transmit receive antenna for use by the both the receiver and the transmitter.

20. An underwater detection system as claimed in claim 1, wherein at least one of said transmitter and receiver incorporates a multi-resonant loop antenna.

21. An underwater detection system as claimed in claim 1, wherein said comparison of said monitored signals involves comparing a spectrum of said received signal to a spectrum of a received signal from a previous point in time.

22. An underwater detection system as claimed in claim 17 further comprising a common antenna terminal wherein a duplexing device operating in the manner of a telephony hybrid is used to separate transmit and receive signals at a said common antenna terminal.

23. An underwater detection system as claimed in claim 22 further comprising an impedance adjustment means for adjusting an impedance connected across at least one port of said duplexing.

24. An underwater detection system as claimed in claim 2 further comprising an electrically conductive cable for distributing a clock reference signal among each of said multiple transmitters.

25. An underwater detection system as claimed in claim 16, wherein said communication means sends an alarm event or target characteristics to said remote monitoring station.

26. An underwater detection system as claimed in claim 25, wherein said communication means comprises a cabled.

27. An underwater detection system as claimed in claim 25, wherein said communication means comprises a radio modem.

28. An underwater detection system as claimed in claim 2, wherein at least one of said multiple transmitters or said at least one receiver is optimised for operation through air.

29. (canceled)

30. A method for detecting objects underwater comprising: transmitting electromagnetic and/or magneto-inductive signals to a receiver through water; monitoring a received signal at said receiver and using said monitored signal both as a reference and to identify any change or changes in said received signal in order to detect the presence of an interposing object.

31. A method as claimed in claim 30, wherein said change or changes in said received signal include changes to the shape and/or amplitude and/or phase of one or more components of the received frequency spectrum.

32. A method for detecting underwater objects as claimed in claim 30 further comprising extracting an un-modulated carrier from a code spread signal for spectral analysis and using the results of the spectral analysis to detect objects.

33. A computer program, or computer program product, preferably on a data carrier or computer readable medium, the computer program having code or instructions for spectrally analysing an un-modulated carrier from a code spread signal and using the results of the spectral analysis to detect underwater objects.

34. An underwater detection system as claimed in claim 9, wherein said orthogonal signal properties are based on the use of carrier signals in phase quadrature.

35. An underwater detection system as claimed in claim 1 further comprising multiple receivers for receiving said transmitted signals wherein each of said multiple receivers is associated with a different detection region.

36. An underwater detection system as claimed in claim 35, wherein said detection regions are combined to provide a security fence.

37. An underwater detection system as claimed in claim 36, wherein said security fence encircles a defined protection region.

38. An underwater detection system as claimed in claim 1, wherein said comparison of said monitored signals enables detection of the presence of an object passing between said transmitter and said receiver.

39. An underwater detection system as claimed in claim 1, wherein said change in said received signal produces a broadened spectrum of said received signal compared with an earlier received signal.

40. An underwater detection system as claimed in claim 1, wherein said transmitted signal has a carrier frequency which is less than 100 kHz.
